(19) United States
(12) Patent Application Publication
(10) Pub. No.: US 2026/0164353 A1
(43) Pub. Date: Jun. 11, 2026

(54) SYNCHRONIZING ENERGIZERS VIA COORDINATED RESTRICTED TARGET WAKE TIME (CR-TWT) MECHANISM

(71) Applicant: Cisco Technology, Inc., San Jose, CA (US)

(72) Inventors: Domenico Ficara, Essertines-sur-Yverdon (CH); Ugo Mario Campiglio, Morges (CH); Juan Carlos Zuniga, Montreal (CA); Jerome Henry, Pittsboro, NC (US)

(21) Appl. No.: 19/395,322

(22) Filed: Nov. 20, 2025

Related U.S. Application Data
(60) Provisional application No. 63/729,520, filed on Dec. 9, 2024.

(51) Int. Cl. H04W 52/02

(52) U.S. Cl. CPC H04W 52/0216; H04W 52/0219

(57) ABSTRACT

Techniques are presented for improving wireless spectrum usage in Wireless Power Transfer (WPT) in the case of overlapping wireless networks. In one embodiment, the access points in the same wireless network synchronize over the Distributed System (DS) or over-the-air to decide when to schedule energizing operations in the network they serve. APs can elect a lead AP to perform the scheduling or to delegate the computation to a WPT scheduling function that can run on a separate network component that is provided with all the power requirements of Ambient Power (AMP) devices in the network. In another embodiment, APs in overlapping networks use Controlled Reserve Target Wake Time (CR-TWT) operations to define the schedule requirements for energizing functionality.

### CROSS REFERENCE TO RELATED APPLICATION

This application claims priority to U.S. Provisional Application No. 63/729,520, filed Dec. 9, 2024, the entirety of which is incorporated herein by reference.

### TECHNICAL FIELD

The present disclosure relates to wireless networks.

### BACKGROUND

An amendment to Institute of Electrical and Electronics Engineers (IEEE) 802.1bp defines modifications to the IEEE section 802.11 Medium Access Control (MAC) layer and Physical Layer (PHY) to enable operation of an Ambient Power communication (AMP) station/client (STA) powered using energy harvesting techniques. One such energy harvesting technique is a Wireless Power Transfer (WPT) protocol that is configured to facilitate wireless power transfer from an access point (AP) or from an energizer in a network to an AMP STA in the network. When the wireless spectrum is being used to transmit power, the wireless spectrum cannot be used to transmit communications between stations and APs.

### BRIEF DESCRIPTION OF THE DRAWINGS

FIG. 1 is a diagram of overlapping wireless networks in which the techniques presented herein may be employed, according to an example embodiment.

FIG. 2 is a diagram of an example schedule for energizing devices in overlapping networks, according to an example embodiment.

FIG. 3 is a diagram illustrating an environment in which energizing devices transmit energizing frames to AMP stations in a wireless network in accordance with an energizing schedule, according to an example embodiment.

FIG. 4 is a flow chart of a method of generating an energizing schedule based on requirements of AMP stations in overlapping wireless networks and transmitting energizing frames to one or more AMP stations in a wireless network based on the energizing schedule, according to an example embodiment.

FIG. 5 illustrates a hardware block diagram of a device that may perform the functions of access point in connection with the techniques presented herein.

### DESCRIPTION OF EXAMPLE EMBODIMENTS

### Overview

In one embodiment, a method is provided for generating an energizing schedule based on requirements of stations in overlapping wireless networks and transmitting energizing frames to one or more stations in a wireless network based on the energizing schedule. A first access point in a first wireless network transmits an energizing schedule to a second access point in a second wireless network. The first wireless network and the second wireless network at least partially overlap, and the energizing schedule indicates one or more times during which one or more energizers in the first wireless network are to send energizing frames to one or more stations in the first wireless network to wirelessly power the one or more stations in the first wireless network. The first access point obtains, from the second access point, an indication that the energizing schedule satisfies requirements of the second wireless network. The one or more energizers transmit energizing frames to the one or more stations in the first wireless network at the one or more times indicated by the energizing schedule.

### Example Embodiments

In a wireless local area network (WLAN) or Wi-Fi® wireless network, one or more wireless APs may provide wireless Radio Frequency (RF) coverage over which one or more wireless devices (e.g., phones, wearable devices, tablets, sensors, Internet of Things (IoT) devices etc.) can connect in order to connect to one or more data networks (e.g., the public Internet, an enterprise network operated by an enterprise entity (e.g., a business, institution, university, etc.)), and/or the like, or to another device. An amendment to IEEE section 802.1bp defines modifications to the IEEE 802.11 Medium Access Control (MAC) layer and the Physical Layer (PHY) to enable operation of an Ambient Power communication (AMP) station/client (STA) powered using energy harvesting techniques, such as a Wireless Power Transfer (WPT) protocol. A WPT protocol facilitates wireless power transfer from an AP or from an energizer/energizing function to an AMP STA. An energizer may be an energizing function within an AP or a separate network component that is not within an AP, but has to coordinate its operations with the AP.

Ideally, energizers in a given area may be synchronized to enable coordination among the energizers so that the entire area (within radio frequency proximity of the energizers) benefits from a reduced spectrum usage due to the energizing functionality. Synchronizing the energizers is useful for several reasons. First, if several energizers send their energizing frames at the same time, the AMP STA that receives the energizing frames from the energizers will receive more energy. Second, during a time in which energizing frames are using the over-the-air medium, no other activity can happen on the same channel, but simultaneous energizing activities can occur. For example, communications between APs and STAs may not be transmitted or received on a channel when energizing frames are being transmitted on the channel. However, energizing frames may be transmitted to multiple STAs simultaneously. There is a need to coordinate usage of the wireless spectrum between wireless communications and wireless power transfer.

Presented herein are techniques for improving wireless spectrum usage in overlapping wireless networks, such as Overlapping Basic Service Sets (OBSS), during Wireless Power Transfer (WPT) for IEEE 802.11bp. In one embodiment, APs in the same network (e.g., same BSS) may synchronize over the Distribution System (DS) or over-the-air to determine when to schedule energizing operations in the network they serve. For example, the APs in the network may elect a lead AP to perform the scheduling or to delegate the computation to a WPT scheduling function that is provided with the power requirements of Ambient Power (AMP) devices/stations in the network. The WPT scheduling function may run on a separate network component than the lead AP.

In another embodiment, APs in overlapping networks may use Coordinated Restricted Target Wake Time (CR-TWT) operations (as defined in the IEEE 802.11bn amendment) to define each schedule requirement for energizing functionality. TWT (Target Wake Time) is a mechanism in wireless networks that allows devices (e.g., stations or clients) to schedule specific times in which the devices wake up and communicate with their serving AP. The use of the TWT mechanism reduces unnecessary activity and helps save power by ensuring devices are active only at predetermined times, instead of continuously scanning for data or maintaining their radio transceivers in a powered-up state. Restricted TWT (R-TWT) was introduced in IEEE section 802.11be. CR-TWT, defined in IEEE 802.11bn, is a more advanced variation of TWT that introduces restrictions on TWT, reserving the medium during TWT Service Periods (SPs) for specific STAs (SP members) and traffic identifiers (TIDs). CR-TWT applies R-TWT to overlapping basic service sets so that the medium reservation is respected by other basic service sets that share the same channel.

According to some embodiments, one AP of each overlapping wireless network may be elected (with any method heretofore known or hereinafter developed) to be in charge of communication with the overlapping network. For example, an elected AP in a network may be in charge of communicating with another elected AP in another network. The elected AP may be selected or chosen based on its position and capabilities. The elected AP may be referred to herein as the “delegated AP.” Each delegated AP may communicate with a counterpart delegated AP in a neighbor/overlapping network and may negotiate CR-TWT parameters. Delegated APs may be recognizable via advertised capabilities in communications such as beacons, probe-responses, etc.

Embodiments described herein provide for coordinating energizing schedules among overlapping wireless networks. Overlapping wireless networks are wireless networks that are in sufficient proximity to each other such that if operating on the same channel(s) would interfere with each other. According to embodiments described herein, a delegated AP in a wireless network may transmit a proposed energizing schedule to a delegated AP in an overlapping wireless network. In one embodiment, the proposed energizing schedule may be generated based on WPT constraints for the devices in the network. The delegated AP in the overlapping wireless network may accept the proposed energizing schedule or propose a refinement to the activity parameters. If a refinement to the energizing schedule is proposed, the delegated APs may negotiate scheduling of energizing until an agreement is reached. Once an agreement is reached, the delegated APs may report the agreed upon energizing schedule to the WPT scheduling functions in their respective networks so that energizers in each network may be synchronized and the energizers in the overlapping networks may be coordinated. The energizers may transmit energizing frames to the devices in their corresponding networks based on the energizing schedule.

Thus, present embodiments improve the technical field of wireless power transfer in wireless networks by coordinating energizing schedules in overlapping wireless networks. Present embodiments therefore increase the efficiency of performing wireless power transfer by scheduling transmission of energizing frames by several energizers at the same time, which increases the energy received at devices that are being wirelessly charged. In addition, the present embodiments increase the efficiency of communications in the wireless networks by scheduling times during which energizing frames are transmitted, which allows for communications to be transmitted around known energizing frame transmission times, channels, and durations. Thus, present embodiments provide the practical application of coordinating energizing schedules among overlapping wireless networks so that wirelessly powered devices in the overlapping wireless networks benefit from increased power when receiving energizing frames and devices in the overlapping network may send and receive communications based on the energizing schedule.

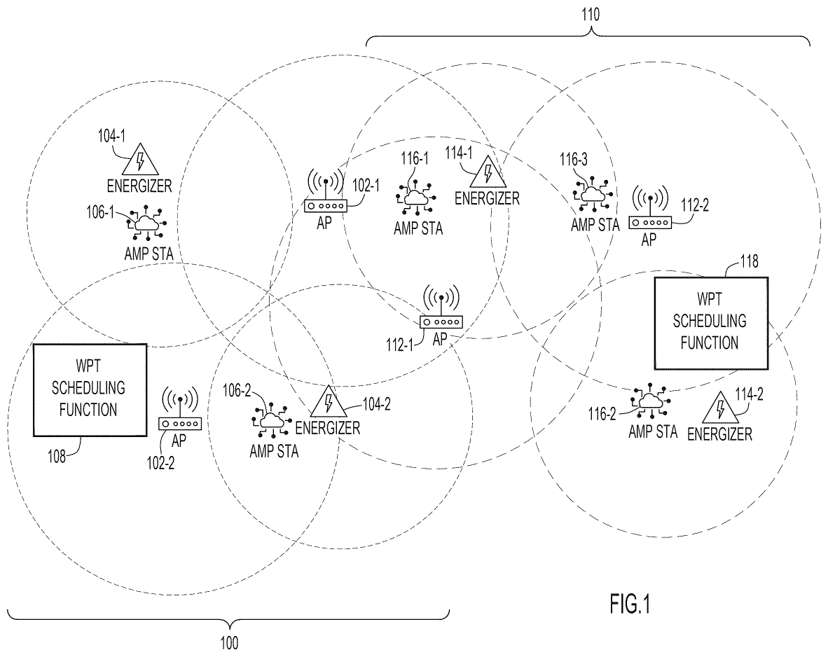

Reference is now made to FIG. 1. FIG. 1 is a diagram of an environment that includes network 100 and network 110, which overlap at least partially. Networks 100 and 110 may be wireless networks that provide wireless radio frequency (RF) coverage to allow one or more wireless devices to connect to one or more data networks. Networks 100 and 110 may additionally include devices that provide wireless power to one or more devices in the networks.

Network 100 includes AP 102-1, AP 102-2, energizer 104-1, energizer 104-2, ambient power (AMP) station (STA) 106-1, AMP STA 106-2, and WPT scheduling function 108. Network 110 includes AP 112-1, AP 112-2, energizer 114-1, energizer 114-2, AMP STA 116-1, AMP STA 116-2, AMP STA 116-3, and WPT scheduling function 118. APs 102-1 and 102-2 may provide wireless RF coverage to AMP STAs 106-1 and 106-2 and to other devices in network 100 that are not illustrated in FIG. 1. Similarly, APs 112-1 and 112-2 may provide wireless RF coverage to AMP STAs 116-1, 116-2, and 116-3 and to other devices in network 110 that are not illustrated in FIG. 1. Although FIG. 1 illustrates two overlapping networks, that network 100 includes two APs, two energizers, and two AMP STAs, and network 110 includes two APs, two energizers, and three AMP STAs, the techniques described herein may be applied to any number of overlapping networks that include any number of devices (e.g., APs, energizers, AMP STAs, etc.).

Energizers 104-1 and 104-2 may transmit energizing frames to AMP STAs 106-1 and 106-2, and energizers 114-1 and 114-2 may transmit energizing frames to AMP STAs 116-1 to 116-3. In some embodiments, AMP STAs 106-1, 106-2, 116-1, 116-2, and 116-3 may be simple or basic devices such as sensors (e.g., temperature sensors, humidity sensors), power switches, or other devices that do not need to be powered up all the time. In other embodiments, AMP STAs 106-1, 106-2, 116-1, 116-2, and 116-3 may be other types of devices or stations that, for example, send data and other communications. The AMP STAs may receive energizing frames from the energizers and harvest the energy to use for transmitting a message or performing another task. In some embodiments, the AMP STAs may include a capacitor, and the AMP STAs may store the received energy using the capacitor.

In some embodiments, the energizers may be energizer functions integrated in one or more of the APs. In other embodiments, the energizers may be separate network components (i.e., not within the APs) that coordinate with the APs and use the Wi-Fi spectrum to transmit energizing frames to the AMP STAs. The energizers may transmit energy to the AMP STAs on the same channels used to transmit communications to the devices in the networks. When an energizer is transmitting energy frames, the devices in the networks cannot transmit communication frames on the same channel. It would be beneficial to synchronize the energizers in overlapping networks so that the energizing frames may be transmitted at known times and the communications (e.g., Wi-Fi signals transmitted and received) may be performed when the energizing frames are not being transmitted.

WPT scheduling function 108 may coordinate the energizing schedules of energizers 104-1 and 104-2 in network 100 and WPT scheduling function 118 may coordinate the energizing schedules of energizers 114-1 and 114-2 in network 110. WPT scheduling functions 108 and 118 may be functions of standalone devices or may be integrated into an AP. WPT scheduling functions 108 and 118 may coordinate the energizing schedules for the energizers in their networks based on the WPT constraints or requirements for the AMP STAs in their networks. For example, WPT scheduling function 108 may coordinate the energizing schedules of energizers 104-1 and 104-2 based on the WPT constraints or requirements of AMP STAs 106-1 and 106-2, and WPT scheduling function 118 may coordinate the energizing schedules of energizers 114-1 and 114-2 based on the WPT constraints or requirements of AMP STAs 116-1 to 116-3. However, the WPT scheduling function in one network may not be aware of WPT constraints or requirements of AMP STAs in another network.

According to embodiments presented herein, APs in overlapping networks may use Coordinated Restricted Target Wake Time (CR-TWT) operations to define schedule requirements for energizing functionality. CR-TWT allows APs in neighboring networks to negotiate with each other to coordinate schedules for performing operations to protect each other's channel access by assigning exclusive time slots or service periods (SPs) for specific devices.

According to embodiments described herein, delegated APs in overlapping networks may communicate with each other to coordinate an agreed upon energizing schedule for transmitting energizing frames to AMP STAs in each network. In the example illustrated in FIG. 1, AP 102-1 may be a delegated AP for network 100 and AP 112-1 may be a delegated AP for network 110. AP 102-1 and AP 112-1 may have been elected as delegated APs due to their locations and their capabilities. For example, AP 102-1 and AP 112-1 may be the only APs in the two networks that can detect each other.

According to some embodiments, the initiating delegated AP may be instructed by the WPT scheduling function in the network about WPT constraints or requirements for the network's AMP STAs. For example, WPT scheduling function 108 may provide AP 102-1 with information about the WPT constraints/requirements for AMP STAs 106-1 and 106-2. The initiating delegated AP 102-1 may propose a suggested schedule for an energizing activity that is to happen in the future to the overlapping/neighbor network delegated AP 112-1. The proposed energizing schedule may include, for example, a timestamp, duration, channel, etc., for one or more energizing activities (e.g., energizing activities associated with one or more APs and/or energizers).

The responding delegated AP 112-1 may accept the proposed energizing schedule or propose a refinement to the scheduling activity parameters. For example, if the proposed energizing schedule satisfies the WPT requirements/constraints of AMP STAs 116-1 to 116-3, AP 112-1 may accept the proposed energizing schedule. If the proposed energizing schedule does not satisfy the WPT requirements/constraints of AMP STAs 116-1 to 116-3, AP 112-1 may propose a refinement to the energizing schedule. In this case, AP 102-1 and AP 112-1 may continue to propose refinements to the energizing schedule until the energizing schedule meets the requirements of the AMP STAs in both networks.

Once agreement between the delegated APs is obtained, the delegated APs may report to the WPT scheduling function so that energizers can be synchronized across the different networks. For example, AP 102-1 may report the agreed upon energizing schedule to WPT scheduling function 108 and AP 112-1 may report the agreed upon energizing schedule to WPT scheduling function 118. The WPT scheduling functions of each network may take into account each other's schedule to produce a common schedule to coordinate energizing AMP STAs in both networks.

In one embodiment, the negotiating AP may propose more than one energizing activity. For example, AP 102-1 may propose a schedule of repeating energizing events. In this case, AP 102-1 may propose times for energizing the AMP STAs and the energizing times may repeat periodically (e.g., every n seconds). By proposing a schedule of repeating energizing events, the energizers may continuously transmit energizing frames to the AMP STAs without the APs repeatedly coordinating energizing schedules.

In yet another embodiment, the WPT scheduling functions of the overlapping networks may communicate with each other via the delegated APs with upper layer protocols and then define CR-TWT operations when negotiation is complete. For example, AP 102-1 and AP 112-1 may communicate using upper layer protocols to determine energizing parameters based on AMP STA requirements received from WPT scheduling function 108 and WPT scheduling function 118. Once the negotiation is complete, CR-TWT operations for networks 100 and 110 may be defined based on the schedule.

In still another embodiment, a first network (e.g., network 100) that created a WPT schedule may advertise the WPT schedule in the delegated AP's beacon. For example, AP 102-1 may advertise a proposed WPT schedule in a beacon. An overlapping network (e.g., network 110) may use the known WPT schedules advertised by overlapping networks (e.g., network 100 and any other overlapping network) and requirements of the AMP STAs in the network (e.g., AMP STAs 116-1 to 116-3) as input to create a WPT schedule that matches the schedule advertised by network 100. If the schedule advertised by AP 102-1 does not satisfy the requirements of the AMP STAs 116-1 to 116-3, WPT scheduling function 118 may augment the schedule advertised by AP 102-1 by adding new energizing periods. Once the schedule associated with network 110 is established, network 110 may share the schedule with network 100 and any other neighboring/overlapping networks.

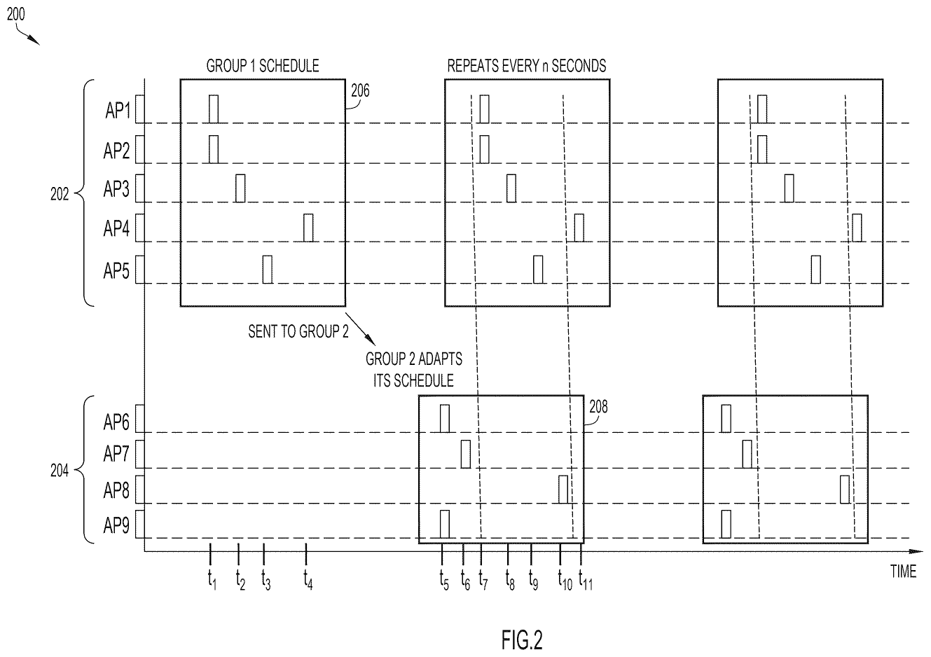

Reference is now made to FIG. 2. FIG. 2 is a diagram of an example schedule 200 for energizing devices in overlapping networks. The schedule 200 illustrates times at which energizing frames are transmitted by energizing functions associated with APs in different networks. In this example, AP1, AP2, AP3, AP4, and AP5 are associated with network 202 and AP6, AP7, AP8, and AP9 are associated with network 204, which overlaps with network 202. The energizing functions may be integrated with the APs or may be energizers associated with different network devices that coordinate with the APs to transmit energizing frames. Although schedule 200 illustrates energizing schedules for nine APs in two networks, an energizing schedule may be generated for any number of APs in any number of overlapping networks.

In the schedule 200, a group 1 schedule 206 for energizing AMP STAs in a network 202 has been generated based on the requirements of the AMP STAs. For example, a delegated AP in network 202 or another device in network 202 may generate group 1 schedule 206 based on the requirements of the AMP STAs in network 202. According to group 1 schedule 206, AP1 and AP2 transmit energizing frames at time t₁, AP3 transmits energizing frames at time t₂, AP5 transmits energizing frames at time t₃, and AP4 transmits energizing frames at time t₄. A delegated AP in network 202 may transmit the group 1 schedule 206 to a delegated AP in network 204. Group 1 schedule 206 may repeat every n seconds so each AP/energizing function in network 202 may transmit the energizing frames every n seconds according to the schedule.

The delegated AP in network 204 may receive the group 1 schedule 206 and may determine that the group 1 schedule 206 satisfies the requirements of the AMP STAs in network 204. The delegated AP in network 204 may transmit a message to the delegated AP in network 202 indicating acceptable of the group 1 schedule 206. The delegated AP in network 204 may additionally adapt the WPT/energizing schedule for the APs in network 204 to generate group 2 schedule 208. The delegated AP in network 204 may transmit the group 2 schedule 208 to the delegated AP in network 202. Group 2 schedule 208 may be repeated every n seconds.

As illustrated in FIG. 2, after n seconds, energizers in networks 202 and 204 may transmit energizing frames based on group 1 schedule 206 and group 2 schedule 208. For example, AP6 and AP9 may transmit energizing frames at time t₅, AP7 may transmit energizing frames at time t₆, AP1 and AP2 may transmit energizing frames at time t₇, AP3 may transmit energizing frames at time t₈, AP5 may transmit energizing frames at time t₉, AP8 may transmit energizing frames at time t₁₀, and AP4 may transmit energizing frames at time t₁₁. The energizing schedules may continue to repeat every n seconds so that the requirements of the AMP STAs are satisfied and the energizing schedules do not interfere with one another. Devices in networks 202 and 204 may send communication frames based on the energizing schedule (i.e., during times in which the energizing frames are not being transmitted).

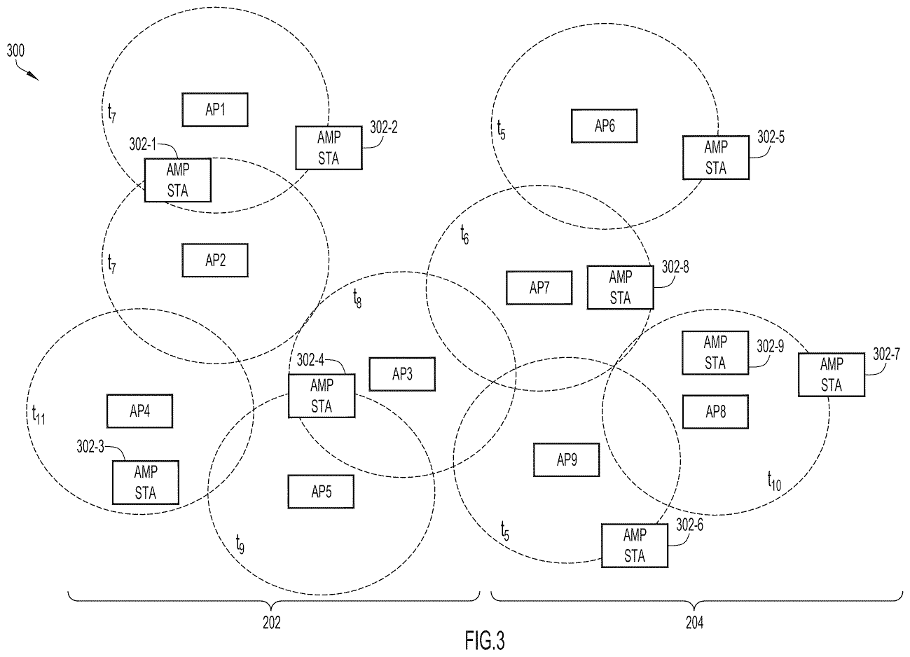

Reference is now made to FIG. 3. FIG. 3 is a diagram illustrating an environment 300 in which energizing functions/APs transmit energizing frames to AMP STAs in accordance with schedule 200 of FIG. 2. Environment 300 includes network 202 and network 204, which are overlapping networks. Network 202 includes AP1-AP5, AMP STA 302-1, AMP STA 302-2, AMP STA 302-3, and AMP STA 302-4. Network 204 includes AP6-AP9, AMP STA 302-5, AMP STA 302-6, AMP STA 302-7, and AMP STA 302-8. The dotted lines around each of the APs is intended to roughly represent the coverage area of the respective APs.

As illustrated in FIG. 3, based on schedule 200, at time t₅, the energizer functions associated with AP6 and AP9 transmit energizing frames. AMP STA 302-5 receives power/energy from the energizing frames transmitted by AP6 and AMP STA 302-6 receives power/energy from AP9. At time t₆, AP7 transmits energizing frames and AMP STA 302-8 receives power/energy from AP7.

At time t₇, AP1 and AP2 transmit energizing frames. Because AMP STA 302-1 is within a range/RF proximity of both AP1 and AP2, AMP STA 302-1 receives power/energy from both AP1 and AP2. In addition, at time t₇, AMP STA 302-2 receives power from AP1. Because AMP STA 302-1 is receiving power from two APs (AP1 and AP2), AMP STA 302-1 may receive more energy than AMP STA 302-2 at time t₇. At time t₈, AP3 may transmit energizing frames and, at time t₉, AP5 may transmit energizing frames. AMP STA 302-4 is within range/RF proximity of both AP3 and AP5 and, therefore, may receive energy at times t₈ and t₉.

At time t₁₀, AP8 may transmit energizing frames and AMP STA 302-7 and AMP STA 302-9 may receive energy. At time t₁₁, AP4 may transmit energizing frames and AMP STA 302-3 may receive energy from the energizing function associated with AP4.

By coordinating the energizing schedules among overlapping networks, the networks may better schedule the transmission and reception of communication and data over channels that are used to transfer wireless power.

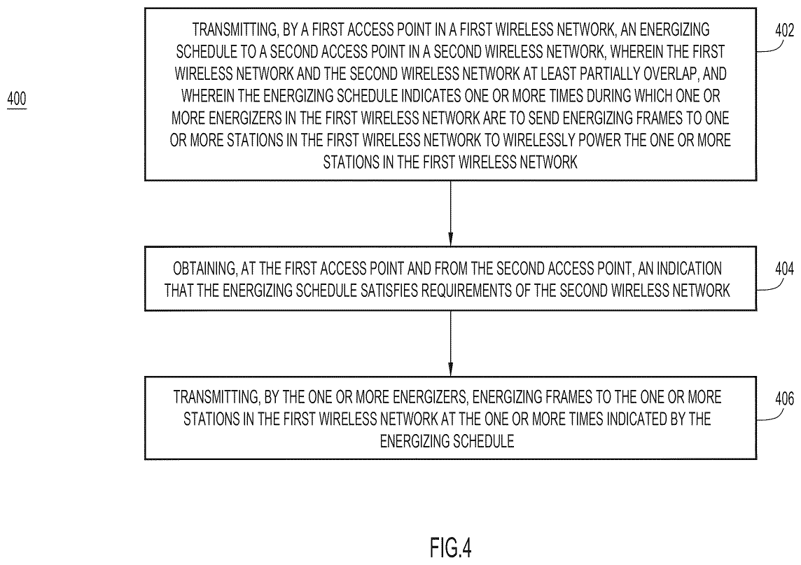

Reference is now made to FIG. 4. FIG. 4 is a flow chart of a method 400 of generating an energizing schedule based on requirements of stations in overlapping wireless networks and transmitting energizing frames to one or more stations in a wireless network based on the energizing schedule. Reference is also made to FIG. 1 for purposes of the description of FIG. 4.

At 402, a first access point in a first wireless network may transmit an energizing schedule to a second access point in a second wireless network. The first wireless network and the second wireless network at least partially overlap, and the energizing schedule indicates one or more times during which one or more energizers in the first wireless network are to send energizing frames to one or more stations in the first wireless network to wirelessly power the one or more stations in the first wireless network. For example, AP 102-1 in network 100 may transmit a proposed energizing schedule to AP 112-1 in network 110. The proposed energizing schedule may indicate one or more times during which energizers 104-1 and 104-2 are to coordinate with APs (e.g., AP 102-1 and AP 102-2) to send energizing frames to AMP STA 106-1 and AMP STA 106-2. The energizing schedule may be based on the constraints/requirements of AMP STAs 106-1 and 106-2 that were transmitted to AP 102-1 by WPT scheduling function 108.

At 404, the first access point may obtain, from the second access point, an indication that the energizing schedule satisfies requirements of the second wireless network. For example, AP 102-1 may obtain an indication from AP 112-1 that the energizing schedule satisfies the constraints of the AMP STAs (e.g., AMP STA 116-1, AMP STA 116-2, and AMP STA 116-3) in network 110. AP 102-1 may additionally obtain, from AP 112-1, a schedule for transmitting energizing frames to AMP STAs in network 110 that was generated based on the proposed energizing schedule generated from the AMP STAs in network 100.

At 406, the one or more energizers may transmit energizing frames to the one or more stations in the first wireless network at the one or more times indicated by the energizing schedule. For example, WPT scheduling function 108 may synchronize the energizers 104-1 and 104-2 based on the energizing schedule to transmit the energizing frames. Energizers 104-1 and 104-2 may coordinate with AP 102-1 and AP 102-2 to transmit the energizing frames or the energizing functions may be integrated with AP 102-1 and/or AP 102-2, and AP 102-1 and 102-2 may transmit the energizing frames to the AMP STAs 106-1 and 106-2.

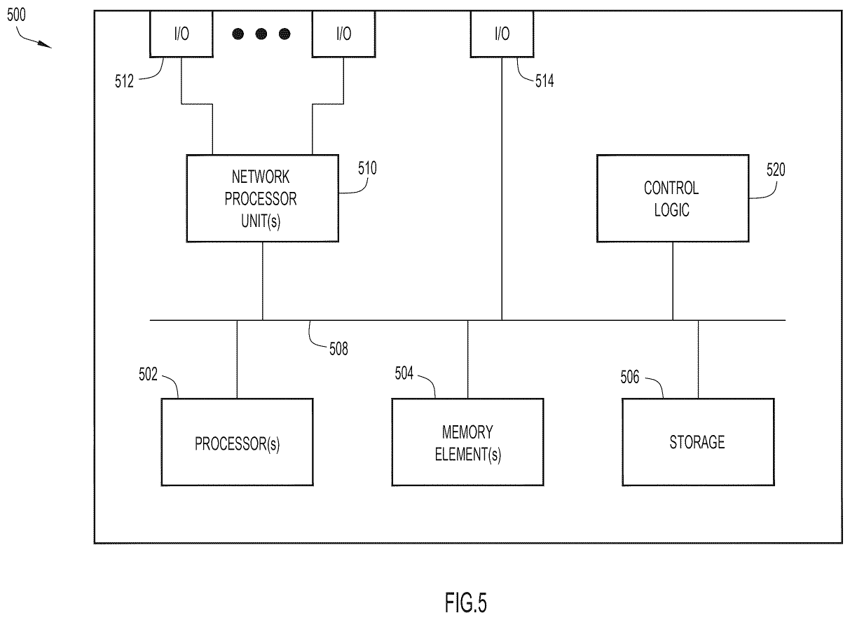

Referring to FIG. 5, FIG. 5 illustrates a hardware block diagram of a device 500 that may perform functions associated with operations discussed herein in connection with the techniques presented herein. In various embodiments, a computing device or apparatus, such as device 500 or any combination of devices 500, may be configured as any entity/entities as discussed for the techniques depicted presented herein in order to perform operations of the various techniques discussed herein. For example, the device 500 may represent an AP or a wireless network controller.

In at least one embodiment, the device 500 may be any apparatus that may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520. In various embodiments, instructions associated with logic for device 500 can overlap in any manner and are not limited to the specific allocation of instructions and/or operations described herein.

In at least one embodiment, processor(s) 502 is/are at least one hardware processor configured to execute various tasks, operations and/or functions for device 500 as described herein according to software and/or instructions configured for device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with device 500, and/or logic configured for memory element(s) 504 and/or storage 506. For example, any logic described herein (e.g., control logic 520) can, in various embodiments, be stored for device 500 using any combination of memory element(s) 504 and/or storage 506. Note that in some embodiments, storage 506 can be consolidated with memory element(s) 504 (or vice versa), or can overlap/exist in any other suitable manner.

In at least one embodiment, bus 508 can be configured as an interface that enables one or more elements of device 500 to communicate in order to exchange information and/or data. Bus 508 can be implemented with any architecture designed for passing control, data and/or information between processors, memory elements/storage, peripheral devices, and/or any other hardware and/or software components that may be configured for device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between device 500 and other systems, entities, etc., via network I/O interface(s) 512 (wired and/or wireless) to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between device 500 and other systems, entities, etc. to facilitate operations for various embodiments described herein. In various embodiments, network I/O interface(s) 512 can be configured as one or more Ethernet port(s), Fibre Channel ports, any other I/O port(s), and/or antenna(s)/antenna array(s) now known or hereafter developed. Thus, the network processor unit(s) 510 and/or network I/O interface(s) 512 may include suitable interfaces for receiving, transmitting, and/or otherwise communicating data and/or information in a network environment.

I/O interface(s) 514 allow for input and output of data and/or information with other entities that may be connected to device 500. For example, I/O interface(s) 514 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a method is provided that includes transmitting, by a first access point in a first wireless network, an energizing schedule to a second access point in a second wireless network, wherein the first wireless network and the second wireless network at least partially overlap, and wherein the energizing schedule indicates one or more times during which one or more energizers in the first wireless network are to send energizing frames to one or more stations in the first wireless network to wirelessly power the one or more stations in the first wireless network; obtaining, at the first access point and from the second access point, an indication that the energizing schedule satisfies requirements of the second wireless network; and transmitting, by the one or more energizers, energizing frames to the one or more stations in the first wireless network at the one or more times indicated by the energizing schedule.

In one example, the method further includes obtaining, by the first access point and from a Wireless Power Transfer (WPT) scheduling function in the first wireless network, WPT constraints for the one or more stations; generating the energizing schedule based on the WPT constraints; and transmitting the energizing schedule to the WPT scheduling function in response to obtaining the indication that the energizing schedule satisfies the requirements of the second wireless network, wherein the WPT scheduling function coordinates the one or more energizers to transmit the energizing frames to the one or more stations based on the energizing schedule.

In another example, the energizing schedule indicates a timestamp, a duration, and a channel over which the energizing frames are to be transmitted to the one or more stations in the first wireless network. In another example, obtaining the indication that the energizing schedule satisfies the requirements of the second wireless network includes: obtaining, from the second access point, a proposed modification to the energizing schedule; modifying the energizing schedule based on the proposed modification to produce a modified energizing schedule; transmitting the modified energizing schedule to the second access point; and obtaining the indication that the energizing schedule satisfies the requirements of the second wireless network.

In another example, the method further comprises negotiating, by the first access point, Coordinated Restricted Target Wake Time (CR-TWT) operations with the second access point based on the energizing schedule. In another example, transmitting the energizing schedule includes advertising the energizing schedule using a beacon. In another example, the first access point is selected as a designated access point for the first wireless network based on a location and capabilities of the first access point.

In another form, an apparatus is provided in a first wireless network, the apparatus including: a communication interface; a memory storing instructions; and one or more processors, wherein the one or more processors are configured to execute the instructions to perform operations including: transmitting, via the communication interface, an energizing schedule to an access point in a second wireless network, wherein the first wireless network and the second wireless network at least partially overlap, and wherein the energizing schedule indicates one or more times during which one or more energizers in the first wireless network are to send energizing frames to one or more stations in the first wireless network to wirelessly power the one or more stations in the first wireless network; obtaining, via the communication interface from the access point, an indication that the energizing schedule satisfies requirements of the second wireless network; and causing transmission of energizing frames to the one or more stations in the first wireless network at the one or more times indicated by the energizing schedule.

In yet another form, one or more non-transitory computer readable storage media encoded with instructions are provided that, when executed by a processor of an access point device associated with a first wireless network, cause the processor to execute a method including: transmitting an energizing schedule to a second access point in a second wireless network, wherein the first wireless network and the second wireless network at least partially overlap, and wherein the energizing schedule indicates one or more times during which one or more energizers in the first wireless network are to send energizing frames to one or more stations in the first wireless network to wirelessly power the one or more stations in the first wireless network; obtaining, from the second access point, an indication that the energizing schedule satisfies requirements of the second wireless network; and transmitting energizing frames to the one or more stations in the first wireless network at the one or more times indicated by the energizing schedule.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
transmitting, by a first access point in a first wireless network, an energizing schedule to a second access point in a second wireless network, wherein the first wireless network and the second wireless network at least partially overlap, and wherein the energizing schedule indicates one or more times during which one or more energizers in the first wireless network are to send energizing frames to one or more stations in the first wireless network to wirelessly power the one or more stations in the first wireless network;
obtaining, at the first access point and from the second access point, an indication that the energizing schedule satisfies requirements of the second wireless network; and
transmitting, by the one or more energizers, energizing frames to the one or more stations in the first wireless network at the one or more times indicated by the energizing schedule.

2. The method of claim 1, further comprising:
obtaining, by the first access point and from a Wireless Power Transfer (WPT) scheduling function in the first wireless network, WPT constraints for the one or more stations;
generating the energizing schedule based on the WPT constraints; and
transmitting the energizing schedule to the WPT scheduling function in response to obtaining the indication that the energizing schedule satisfies the requirements of the second wireless network, wherein the WPT scheduling function coordinates the one or more energizers to transmit the energizing frames to the one or more stations based on the energizing schedule.

3. The method of claim 1, wherein the energizing schedule indicates a timestamp, a duration, and a channel over which the energizing frames are to be transmitted to the one or more stations in the first wireless network.

4. The method of claim 1, wherein obtaining the indication that the energizing schedule satisfies the requirements of the second wireless network comprises:
obtaining, from the second access point, a proposed modification to the energizing schedule;
modifying the energizing schedule based on the proposed modification to produce a modified energizing schedule;
transmitting the modified energizing schedule to the second access point; and
obtaining the indication that the energizing schedule satisfies the requirements of the second wireless network.

5. The method of claim 1, further comprising:
negotiating, by the first access point, Coordinated Restricted Target Wake Time (CR-TWT) operations with the second access point based on the energizing schedule.

6. The method of claim 1, wherein transmitting the energizing schedule includes advertising the energizing schedule using a beacon.

7. The method of claim 1, wherein the first access point is selected as a designated access point for the first wireless network based on a location and capabilities of the first access point.

8. An apparatus in a first wireless network, the apparatus comprising:
a communication interface;
a memory storing instructions; and
one or more processors, wherein the one or more processors are configured to execute the instructions to perform operations comprising:
transmitting, via the communication interface, an energizing schedule to an access point in a second wireless network, wherein the first wireless network and the second wireless network at least partially overlap, and wherein the energizing schedule indicates one or more times during which one or more energizers in the first wireless network are to send energizing frames to one or more stations in the first wireless network to wirelessly power the one or more stations in the first wireless network;
obtaining, via the communication interface from the access point, an indication that the energizing schedule satisfies requirements of the second wireless network; and
causing transmission of energizing frames to the one or more stations in the first wireless network at the one or more times indicated by the energizing schedule.

9. The apparatus of claim 8, wherein the operations further comprise:
obtaining, via the communication interface from a Wireless Power Transfer (WPT) scheduling function in the first wireless network, WPT constraints for the one or more stations;
generating the energizing schedule based on the WPT constraints; and
transmitting, via the communication interface, the energizing schedule to the WPT scheduling function in response to obtaining the indication that the energizing schedule satisfies the requirements of the second wireless network, wherein the WPT scheduling function coordinates the one or more energizers to transmit the energizing frames to the one or more stations based on the energizing schedule.

10. The apparatus of claim 8, wherein the energizing schedule indicates a timestamp, a duration, and a channel over which the energizing frames are to be transmitted to the one or more stations in the first wireless network.

11. The apparatus of claim 8, wherein the operation of obtaining the indication that the energizing schedule satisfies the requirements of the second wireless network comprises:
obtaining, from the access point, a proposed modification to the energizing schedule;
modifying the energizing schedule based on the proposed modification to produce a modified energizing schedule;
transmitting the modified energizing schedule to the access point; and
obtaining the indication that the energizing schedule satisfies the requirements of the second wireless network.

12. The apparatus of claim 8, wherein the operations further comprise:
negotiating Coordinated Restricted Target Wake Time (CR-TWT) operations with the second access point based on the energizing schedule.

13. The apparatus of claim 8, wherein the operation of transmitting the energizing schedule includes advertising the energizing schedule using a beacon.

14. The apparatus of claim 8, wherein the apparatus comprises a second access point, and wherein the second access point is selected as a designated access point for the first wireless network based on a location and capabilities of the access point.

15. One or more non-transitory computer readable storage media encoded with instructions that, when executed by a processor of an access point device associated with a first wireless network, cause the processor to execute a method comprising:
transmitting an energizing schedule to a second access point in a second wireless network, wherein the first wireless network and the second wireless network at least partially overlap, and wherein the energizing schedule indicates one or more times during which one or more energizers in the first wireless network are to send energizing frames to one or more stations in the first wireless network to wirelessly power the one or more stations in the first wireless network;
obtaining, from the second access point, an indication that the energizing schedule satisfies requirements of the second wireless network; and
transmitting energizing frames to the one or more stations in the first wireless network at the one or more times indicated by the energizing schedule.

16. The one or more non-transitory computer readable storage media of claim 15, wherein the method further comprising:
obtaining, from a Wireless Power Transfer (WPT) scheduling function in the first wireless network, WPT constraints for the one or more stations;
generating the energizing schedule based on the WPT constraints; and
transmitting the energizing schedule to the WPT scheduling function in response to obtaining the indication that the energizing schedule satisfies the requirements of the second wireless network, wherein the WPT scheduling function coordinates the one or more energizers to transmit the energizing frames to the one or more stations based on the energizing schedule.

17. The one or more non-transitory computer readable storage media of claim 15, wherein the energizing schedule indicates a timestamp, a duration, and a channel over which the energizing frames are to be transmitted to the one or more stations in the first wireless network.

18. The one or more non-transitory computer readable storage media of claim 15, wherein obtaining the indication that the energizing schedule satisfies the requirements of the second wireless network comprises:
obtaining, from the second access point, a proposed modification to the energizing schedule;
modifying the energizing schedule based on the proposed modification to produce a modified energizing schedule;
transmitting the modified energizing schedule to the second access point; and
obtaining the indication that the energizing schedule satisfies the requirements of the second wireless network.

19. The one or more non-transitory computer readable storage media of claim 15, wherein the method further comprises:
Negotiating Coordinated Restricted Target Wake Time (CR-TWT) operations with the second access point based on the energizing schedule.

20. The one or more non-transitory computer readable storage media of claim 15, wherein transmitting the energizing schedule includes advertising the energizing schedule using a beacon.
